(19) United States
(12) Patent Application Publication
(10) Pub. No.: US 2026/0016793 A1
(43) Pub. Date: Jan. 15, 2026

(54) CASING EXIT ADVISORY SYSTEM AND METHOD

(71) Applicant: Weatherford Technology Holdings, LLC, Houston, TX (US)

(72) Inventors: Hany Gamal, Dhahran (SA); Miguel Julian Duarte Ballesteros, Houston, TX (US)

(21) Appl. No.: 18/772,179

(22) Filed: Jul. 14, 2024

Related U.S. Application Data
(60) Provisional application No. 63/669,926, filed on Jul. 11, 2024.

(51) Int. Cl. G05B 13/02; G05B 19/4155

(52) U.S. Cl. CPC G05B 13/0265; G05B 19/4155; G05B 2219/45145

(57) ABSTRACT

Techniques for milling a window in the casing of a wellbore involves using a milling system with specific operating parameters controlled by a control apparatus. The control apparatus obtains sensor data during milling, accesses a trained machine learning model to predict an updated milling rate based on this data, and generates updated operating parameters. These updated operating parameters are then used to control the milling system to perform the operation at the new milling rate. The techniques continuously optimize the milling operation by adapting to real-time data and predictions made by the machine learning model.

### CROSS-REFERENCE TO RELATED APPLICATIONS

This application claims the benefit of U.S. Provisional Appl. No. 63/669,926 filed Jul. 11, 2024, which is incorporated herein by reference in its entirety.

### FIELD OF THE DISCLOSURE

The subject matter of the present disclosure is directed to a machine learning advisory system for controlling milling operations to form a window for a casing exit by configuring controllable drilling parameters (e.g., weight on the mill, rotational speed, pumping rate, etc.) to maximize the milling rate and to reduce operation time.

### BACKGROUND OF THE DISCLOSURE

In well construction and completion operations, drilling is performed to form a wellbore in a formation to access hydrocarbons (e.g., crude oil and/or natural gas). To perform the drilling, a drill bit is mounted on a drill string, and the drill string and drill bit are used to drill the wellbore to a predetermined depth. The drill bit is rotated by rotating the drill string using a top drive or rotary table on a surface platform or rig. Additionally or alternatively, the drill bit can be rotated by a downhole motor mounted towards a downhole end of the drill string.

After drilling the wellbore to the predetermined depth, the drill string and drill bit are removed, and a string of casing is lowered into the wellbore. An annulus is thus formed between the casing and the formation. A cementing operation is then conducted to fill this annulus with cement. The combination of cement and the casing strengthens the wellbore and helps isolate certain areas of the formation behind the casing for the production of hydrocarbons.

In some instances, a sidetrack is drilled into the formation to access additional areas of the formation. For example, after the primary wellbore has been drilled in the formation, operators can then drill an angled lateral wellbore that diverts off from the primary wellbore at a chosen depth. Generally, the primary wellbore is first cased with casing and cemented. Then, a whipstock is positioned in the casing at the chosen depth where deflection for the sidetrack is desired. A milling tool is run down the casing to the whipstock, which diverts a milling bit in a desired direction to mill an exist in the casing so a lateral or sidetrack wellbore can then be drilled.

Forming such a casing exit is a common well intervention operation performed in the oil and gas industry. The casing exit from the primary wellbore can allow a lateral wellbore to be drilled so more zones in the formation can be accessed. Also, the casing exit can allow operators to bypass obstructions (such as stuck pipe or tool) in the primary wellbore, thereby reducing operating costs. Advantageously, configurations available in the prior art allow operators to run and set a whipstock so a milling tool can mill a window and drill the rathole in a single-trip re-entry operation.

Operators, such as a directional drilling team, plan the milling operation to form the casing exit and rathole. The plan is designed so either a rotating mode or a steering mode is used for drilling in the formation after the casing exit is produced by the milling operation. Based on the plan, a milling tool and a whipstock are run together into the primary wellbore to the predesigned setting depth in the casing. The whipstock is set in the casing using a hydraulic or mechanical anchor system. The milling operation for the casing exit is then started by operating the milling tool to mill a window through the casing and by then kicking off the milling tool to form the rathole. The milling tool can be removed, and a drilling system can be run down the casing to the whipstock to then drill the sidetrack for a lateral wellbore.

A milling operation to form a casing exit is a frequent operation performed in wellbores and is particularly necessary in installations having multilateral wellbores. Unfortunately, executing a quality casing exit often relies on the personal experience and skills of the particular operators. As expected, opinions on the best way to mill a window for a casing exit may vary significantly from one operator to another. However, techniques are available to determine useful milling metrics, such as mill wear, drag through a window for a casing exit, and total time required to mill the window, and these milling metrics can characterize a milling operation to form a casing exit. These milling metrics can be statistically characterized and can be equated to economic metrics, such as costs, rig time, and the like. Using these metrics, operators can have better guidance on how to perform a milling operation to save money and to improve the quality of the casing exit.

In addition to these techniques to characterize the metrics for more efficient milling operations, downhole components available in the art and used in milling a window during a casing exit operation can provide useful information about the window's trajectory. This information can reduce the need check the window during drilling a subsequent section of the casing exit using a motor or rotary steerable drilling systems.

Even with the available techniques and downhole components, operators still need additional ways to improve milling operations to mill a window for a casing exit because these milling operations are so often used for multilateral wellbore designs.

The subject matter of the present disclosure is directed to overcoming, or at least reducing the effects of, one or more of the problems set forth above.

### SUMMARY OF THE DISCLOSURE

Some implementations herein relate to a method. For example, the method may include operating a milling system with a control apparatus by controlling the milling system with one or more current operating parameters to perform a milling operation with a milling rate. The method may also include obtaining sensor data from the milling system with the control apparatus during the milling operation. Furthermore, the method may include accessing a trained machine learning model with the control apparatus during the milling operation. In addition, the method may involve generating, with the control apparatus using the trained machine learning model and the sensor data, an updated milling rate of the milling system. Moreover, the method may include generating, with the control apparatus using the trained machine learning model, one or more updated operating parameters, the updated operating parameters being configured to control the milling system to perform the milling operation according to the updated milling rate. The method may also include operating the milling system with the control apparatus by controlling the milling system with at least one of the updated operating parameters to perform the milling operation. Other embodiments of this aspect include corresponding computer systems, apparatus, and computer programs recorded on one or more computer storage devices, each configured to perform the actions of the methods.

The described implementations may also include one or more additional features. The sensor data can include one or more of a weight on mill, a rotational speed, and a flow rate associated with the milling system. The updated operating parameters can include one or more of an updated weight on mill, an updated rotational speed, and an updated flow rate.

The method can include initially training an untrained machine learning model with the control apparatus by: obtaining historic sensor data collected during one or more historic milling operations; preprocessing the historic sensor data into training data for the untrained machine learning model; training the untrained machine learning model with the training data to generate the trained machine learning model; comparing a prediction accuracy of the trained machine learning model relative to a threshold by testing the trained machine learning model; and saving the trained machine learning model or repeating the training based the comparison.

Obtaining the historic sensor data collected during the historic milling operations may include the historic sensor data collected at least from one or more offset wells of the wellbore. Training the machine learning model with the training data may include using an artificial intelligence regression model. In the method, the step of operating the milling system with the control apparatus may include: generating an output of the updated operating parameters to be selected by an operator of the milling system; receiving a selection of at least one of the updated operating parameters in the generated output; and using the selection when operating the milling system with the control apparatus. The step of operating the milling system with the control apparatus may include automatically controlling the milling system according to an automated control of the control apparatus, where the automated control adjusts the milling system with at least one of the updated operating parameters.

In the method, the step of generating the updated milling rate may include generating a plurality of the updated milling rates, and each of the plurality can be associated with one of a plurality of discrete stages of the milling operation. In the method, the step of generating the updated operating parameters may include: generating a plurality of updated operating parameters, each of the plurality being associated with one of the discrete stages. Controlling the milling system with at least one of the updated operating parameters to perform the milling operation may then include adjusting the milling system with at least one of the updated operating parameters in at least one of the discrete stages. Each of the discrete stages can be defined by a change in physics of the milling system during the milling operation. Each of the discrete stages can be defined by one or more of: a location for an event during the milling operation, a geometric distance from a known reference point, a configuration of the milling system, a configuration for a milling assembly of the milling system, a dimension of the casing, a characteristic of the formation, an angle of attack, a point at which cutting for a given mill begins, a point at which cutout for a given mill begin, an amount of deflection, a cutout point, a core point, and a kickoff point in the milling operation.

Implementations of the described techniques may include hardware, a method or process, or a computer tangible medium. For example, a non-transitory program storage device can have program instructions stored thereon for causing one or more processors to perform a method as described above to mill a window in the casing of a wellbore disposed in a formation.

Some implementations herein relate to a system. For example, the system may include a milling assembly configured to mill a window in the casing during a milling operation. The system may also include a plurality of sensors configured to obtain sensor data at least associated with the milling assembly. Furthermore, the system may include a control apparatus in operable communication with the milling assembly and the sensors, the control apparatus being configured during the milling operation to: obtain the sensor data from the sensors; access a trained machine learning model; generate, using the trained machine learning model and the sensor data, an updated milling rate of the milling assembly; generate, using the trained machine learning model, one or more updated operating parameters, the updated operating parameters being configured to control the milling assembly to perform the milling operation according to the updated milling rate; and control the milling assembly with at least one of the updated operating parameters to operate the milling assembly.

The described implementations for the system may also include one or more of the features disclosed above with respect to the method.

The foregoing summary is not intended to summarize each potential embodiment or every aspect of the present disclosure.

### BRIEF DESCRIPTION OF DRAWINGS

FIG. 1 illustrates a milling system having a control apparatus according to the present disclosure.

FIGS. 2A, 2B, and 2C illustrate portions of the milling system during stages of a milling operation.

FIG. 3 illustrates a hardware configuration for implementing the control apparatus according to the present disclosure.

FIG. 4 illustrates a process to train a machine learning model according to the present disclosure.

FIG. 5 illustrates a framework to train and deploy a machine learning algorithm for use in a machine learning model according to the present disclosure.

FIG. 6 illustrates a process to deploy a machine learning model according to the present disclosure.

FIG. 7 illustrates an example of a machine learning model utilized by a control apparatus of the present disclosure.

FIG. 8 illustrates an example graph comparing predictive accuracy of the machine learning model.

FIG. 9 illustrates an example graph of an updated milling rate produced by the machine learning model relative to an original milling rate.

FIGS. 10A, 10B, and 10C illustrate example graphs of updated operating parameters relative to original operating parameters.

FIG. 11 illustrates a schematic representation the control apparatus using the machine learning model to operate the milling assembly.

FIG. 12 illustrates another schematic representation the control apparatus using the machine learning model to operate the milling assembly.

### DETAILED DESCRIPTION OF THE DISCLOSURE

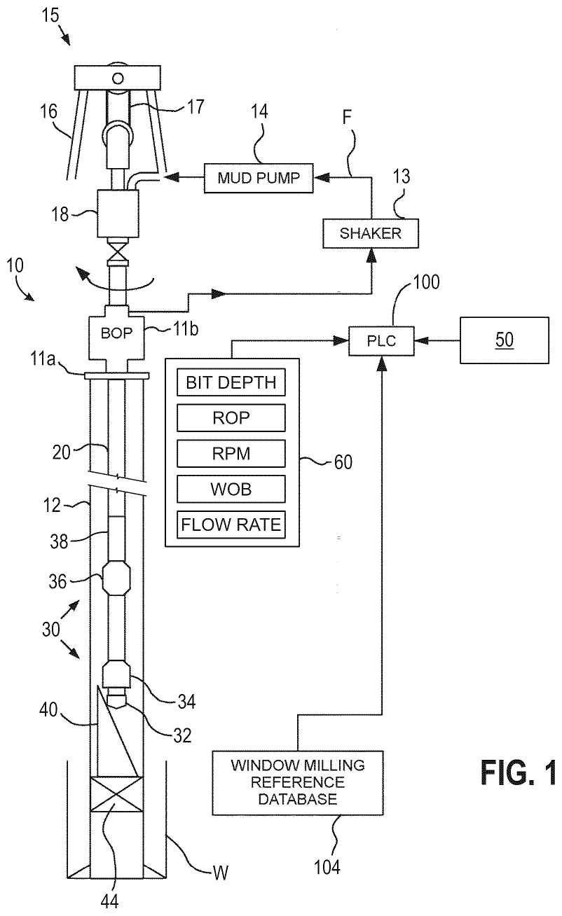

FIG. 1 illustrates a milling system 10 having a control apparatus 100 according to the present disclosure. As shown, the control apparatus 100 may be integrated as part of the milling system 10. In other alternatives, the control apparatus 100 may be a separate component that interfaces with the milling system 10.

In this example, a primary wellbore W has been drilled. A casing string CS has been installed in the primary wellbore W by being hung from a wellhead 11 and cemented in place. Once the casing string CS has been deployed and cemented, a deployment string 20 is deployed into the primary wellbore W to implement a sidetrack milling operation.

In general, the drilling rig 15 may be deployed on land or offshore. If the primary wellbore W is subsea, then the drilling rig 15 may be on a mobile offshore drilling unit, such as a drillship or semisubmersible. Overall, the drilling rig 15 includes a derrick 16 and includes drawworks 17 for supporting a top drive 18. In turn, the top drive 18 supports and rotates the deployment string 20. Alternatively, a Kelly and rotary table (not shown) may be used to rotate the deployment string 20 instead of the top drive 18.

The drilling rig 15 further includes a mud pump 14 operable to pump milling fluid F from of a pit or tank (not shown), through a standpipe and Kelly hose, and to the top drive 18. The milling fluid F can include a base liquid, such as refined oil, water, brine, or a water/oil emulsion. Dissolved or suspended solids, such as organophilic clay, lignite, and/or asphalt, can be used the base liquid of the milling fluid F, thereby forming a mud.

The drilling rig 15 may include a control room (a.k.a. doghouse) (not shown) having a rig controller 60, such as a server, in communication with a sensor array 50 of sensors for monitoring the milling operation. The rig sensors in the sensor array 50 are a data source for the disclosed control apparatus 100, which can record mechanical, hydraulic, and other data with high-frequency and can provide critical information about an operation's performance. Data analytics performed by the control apparatus on the recorded data can provide insights that can improve the operation's performance and can produce cost savings.

The sensor array 50 may include one or more of: a mud pump stroke counter, a hook load cell, a hook (and/or drawworks) position sensor, a standpipe pressure sensor, a wellhead pressure sensor, a torque sub/cell, a turns (top drive or rotary table) counter, and a pipe tally. From the sensor measurements and values input by an operator, the control apparatus 100 can calculate additional operational parameters, such as bit (or BHA) depth (measured and vertical), rate of penetration (ROP), rotational speed (RPM) of the deployment string 20, weight-on-bit (WOB), and pumping or flow rate (Q). Alternatively, one or more of these additional parameters may be measured directly as the other parameters in the sensor array 50, or the parameters may be calculated by any other device or process. The control apparatus 100 may also store one or more wellbore parameters, such as bottomhole depth (measured and vertical).

During the milling operation, a bottom hole assembly (BHA) having a milling assembly 30 and a whipstock 40 is deployed downhole on a deployment string 20, which can use joints of drillpipe screwed together. Alternatively, the deployment string 20 can use coiled tubing instead of drillpipe. The mud pumps 14 at surface pump the milling fluid F, which flows from the standpipe and into the deployment string 20 via a swivel.

As shown here, the milling assembly 30 includes a pilot mill 32, a lead mill 34, and drill collars 38. The milling assembly 30 can also include a trail (i.e., secondary or flex) mill 36, measurement while drilling (MWD) sensors (not shown), logging while drilling (LWD) sensors (not shown), and a float valve (to prevent backflow of fluid from the annulus). The deployment string 20 can also include one or more centralizers (not shown) spaced therealong at regular intervals, and/or the milling assembly 30 can include one or more stabilizers. During the milling operation, the mills 32, 34, 36 can be rotated from the surface by the top drive (or the rotary table), and/or the mills 32, 34, 36 can be rotated downhole by a drilling motor (not shown).

The lead mill 34 and the trail mill 36 can include a tubular housing connected to other components of the milling assembly 30 or to the deployment string 20, such as by a threaded connection. Each mill 32, 34, 36 can further include or more blades formed or disposed around an outer surface of the housing. Cutters may be disposed along each of the blades, such as by pressing, bonding, or threading. The cutters may be made from a hard material, such as ceramic or cermet (i.e., tungsten carbide) or any other material(s) suitable for milling a window.

The whipstock 40 can include an anchor 44, which may or may not include a packer for sealing. During the milling operation, the anchor 44 can be mechanically and/or hydraulically actuated to engage the casing 12. The whipstock 40 is releasably connected (i.e., by one or more shearable fasteners) to the milling assembly 30 for deployment so that the milling operation can be performed in one trip. The whipstock 40 may be releasably connected to the anchor 44 such that the whipstock 40 may be retrieved, an extension (not shown) added, and reconnected to the anchor 44 for milling a second window (not shown). Alternatively, the anchor 44 and/or the whipstock 40 may be set in a separate trip.

During the milling operation, the milling fluid F is pumped down through the deployment string 20 and exits the pilot mill 32, where the pumped milling fluid F can circulate the cuttings away from the milling assembly 30 and can return the cuttings up an annulus formed between the casing 12 and the deployment string 20. The milling fluid F and cuttings (collectively, returns) flow through the annulus to the wellhead 11 and can be discharged to a primary returns line (not shown). Alternatively, a variable choke and rotating control head may be used to exert backpressure on the annulus during the milling operation. The returns may then be processed by a shale shaker 13 to separate the cuttings from the milling fluid F. One or more blowout preventers (BOP) 11b may also be fastened to the wellhead 11a.

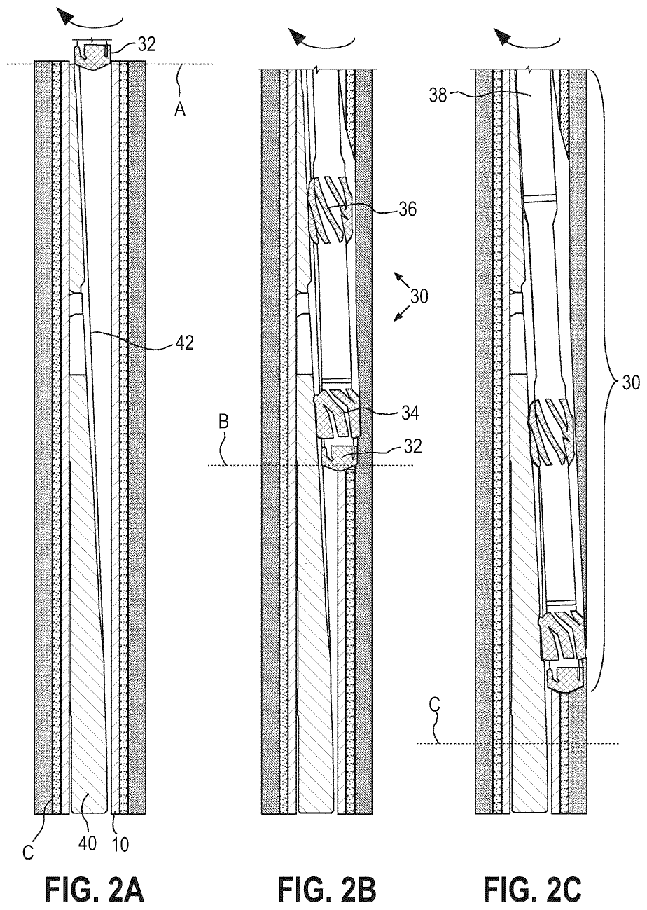

FIGS. 2A, 2B, and 2C illustrate stages of a milling operation conducted using the milling system 10. The milling operation can cut a window in the casing 12 to form a rathole, through which a sidetrack can be formed. In FIG. 2A, the whipstock 40 of the milling assembly 30 is set in the casing 12, and the pilot mill 32 is disengaged from a whip or deflector 42 of the whipstock 40 using conventional techniques. The milling assembly 30 is run in hole at a start point A against the deflector 42, and the milling operation starts milling at a core point B in the casing 12. Milling continues, and the mills 32, 34, 36 approach a kickoff point C as shown in FIG. 2C where the mills 32, 34, 36 can exit the casing 12.

Once the window is milled in the casing 12, the milling assembly 30 may drill a distance into the formation to form a rathole. Then, the milling assembly 30 is retrieved so a drilling assembly having a drill bit can be installed on the drilling system to drill a sidetrack in the formation. The drilling assembly and bit are designed to cut the formation and not to cut the casing 12. If the drilling assembly and bit fails to follow the initial extent of the rathole started by the milling assembly 30, the drilling assembly and bit can encounter the casing 12 and can be damaged.

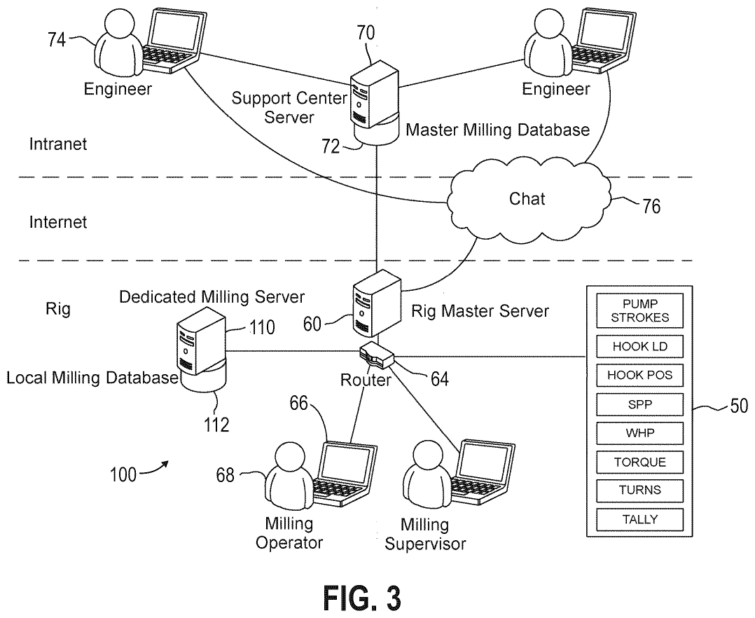

FIG. 3 illustrates a hardware configuration for implementing the control apparatus 100 according to the present disclosure. Certain features of the hardware configuration can be found in U.S. Pat. No. 10,323,500, which is incorporated herein by reference in its entirety.

The control apparatus 100 includes a programmable logic controller (PLC) implemented as analysis and control functions in software operating on one or more computers, such as one or more of a server 110, a laptop 66, a tablet, a personal digital assistant (PDA), and the like. These computers 110, 66 can be a dedicated to the milling operations and can have a local milling database 112, which is discussed below. The analysis and control software may be loaded onto a rig controller 60, such as a rig master server, instead of or in addition to the computers 110, 66.

The software for the analysis and control functions may be loaded onto the computers 110, 66, 60 from a computer readable medium, such as a compact disc or a solid-state drive. As will be appreciated, the computers 110, 66, 60 may each include a central processing unit, memory, an operator interface, such as a keyboard, monitor, and a pointing device, such as mouse or trackpad.

Each milling operation computer 110, 66 may interface with the rig controller 60 via a router 64, and each computer 110, 66 can be connected to the router 64 using any suitable interface, such as by a universal serial bus (USB), Ethernet, or wireless connection. The interface may allow the control apparatus 100 to receive one or more of the rig sensor measurements, the operational parameters, and the wellbore parameters from the rig controller 60 and the sensor array 50 for monitoring the milling operation. Each milling operation computer 110, 66 may also interface with the Internet or an Intranet via the rig controller 60, or each may have its own connection. Remote access and communications 76 between the rig components and a support center server 70 (as well as remote engineers 74) can be obtained through network connections to the rig controller 60.

The milling database 112 may be loaded locally on the milling server 110 and/or accessed (or updated) from a master version via the Internet and/or Intranet. The milling database 112 stores location information for known or expected events during a window milling operation. The location information can include one or more of: a point at which cutting for each mill begins; a point at which cutout for each mill begins; a maximum deflection; start, middle, and end of the core point (B; FIG. 2B); start, middle, and end of the kickoff point (C; FIG. 2C); etc. The location information can be defined as geometric distances from a known reference point, such as a top point (A; FIG. 2A) of the whipstock (40).

In milling the casing exit, the cutout point is the location on the casing where milling operations are to begin (i.e., where the milling assembly (30) engages with the casing (12) to initiate the cut). Based on wellbore geometry, formation characteristics, and the desired exit point, the cutout point is selected so there is sufficient clearance for the milling assembly (30) to establish a clean and precise cut through the casing (12). The core point defines a designated depth within the casing (12) where the milling operation transitions from initial cutting to core milling. In this respect, the core milling involves removing a section of the casing (12) to create a passage for subsequent operations, such as drilling a lateral wellbore. Being based on wellbore trajectory, casing size, and desired lateral entry angle, the core point is positioned to optimize the milling process and to also ensure the milling assembly (30) can be removed after the operation. Finally, the kickoff point defines a depth at which the drilling trajectory deviates from the existing wellbore direction (e.g., where a lateral section for a sidetrack wellbore begins). This kickoff point establishes the desired path of such a lateral section so target zones in the reserve can be reached or so an obstacle can be avoided. These points lead to additional features of interest for the casing exit, such as the start or top of the window and the end or bottom of the window. Additional geometric factors may also be considered to account for the drilling system, such as a rotary steerable system, to be used in a drilling operation to drill a sidetrack from the casing window.

The events may be used to divide the window milling operation into regions or stages, such as a cutout stage, a maximum deflection stage, a core point stage, and a kickoff stage. These and other divisions can be used for stages of a milling operation. Moreover, the database 112 cam store datasets of such location information for various implementation details, such as casing sizes; casing weights; types, sizes, and arrangements of milling assembly (30) and whipstock (40); etc.

The database 112 can also store one or more target values of one or more milling parameters, such as rate of penetration (ROP), rotational speed (RPM), and/or weight-on-mill (WOM), for each stage. As an example for ROP, the database 112 can store a first minimum and maximum ROP for the cutout stage, a second minimum and maximum ROP for the maximum deflection stage, a third minimum and maximum ROP for the core point stage, and a fourth minimum and maximum ROP for the kickoff stage. Instead of minimum and maximum value, a target can be a single value for a given milling parameter. The target value can be predetermined, or it may vary depending on values measured during the milling operation. The target value may be constant or may vary based on a particular implementation detail, such as casing size or weight. If the target value of a particular milling parameter varies based on a particular implementation detail, then the database 112 can store a dataset of target values for the parameter for each particular implementation detail.

Given the location information, target values, and the like stored in the database 112, the analysis and control functions of the control apparatus 100 interfaces with other operational components (e.g., sensor array 50, rig server 60, etc.) and operates a window milling operation using a machine learning model as discussed below. To do this, the analysis and control functions of the control apparatus 100 uses a trained and deployed machine learning model to perform and improve a window milling operation.

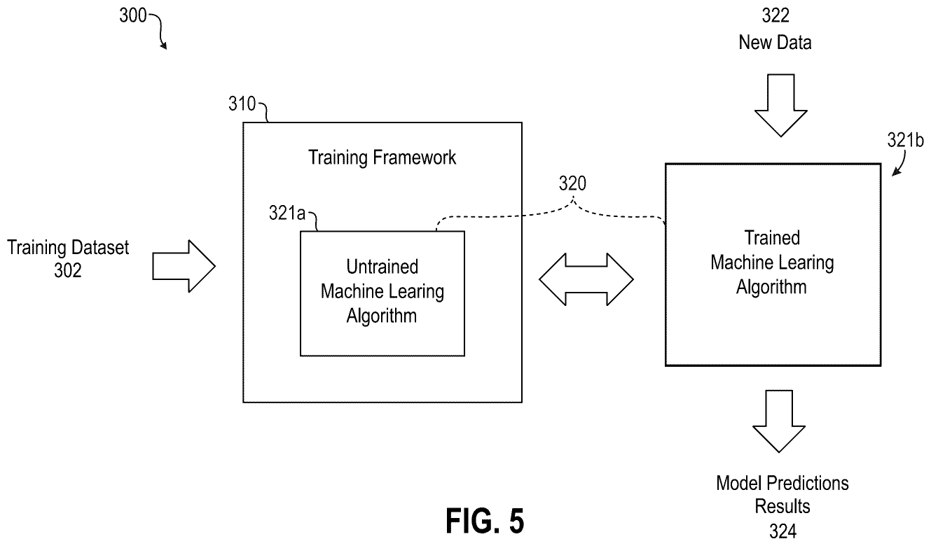

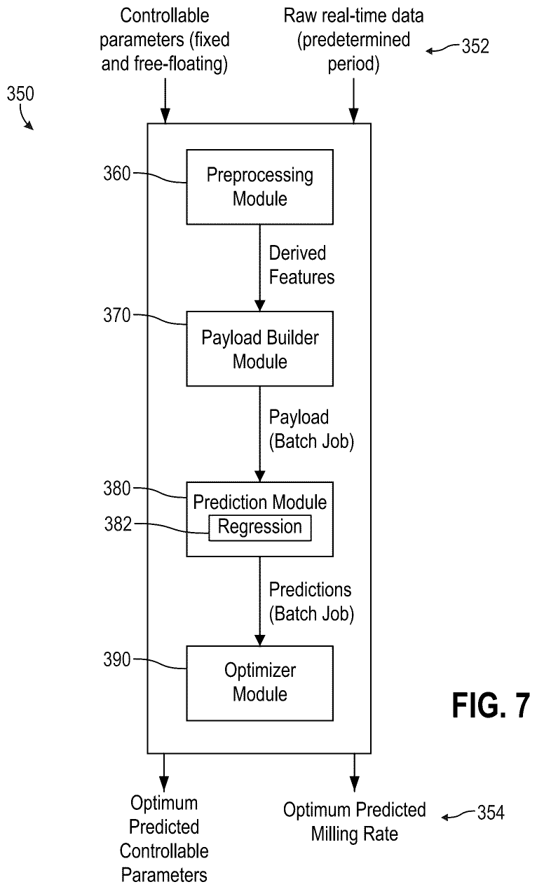

In general, the control apparatus (100) can be used to develop such a machine learning model, or any other appropriate computer system can develop the model for used by the control apparatus (100). As described later, for example, FIG. 5 illustrates an example configuration 300 for a computer system to train and deploy a machine learning algorithm 320 for use in a machine learning model of the present disclosure. Additionally, FIG. 7 illustrates an example of a machine learning model 350 utilized by a control apparatus (100) of the present disclosure.

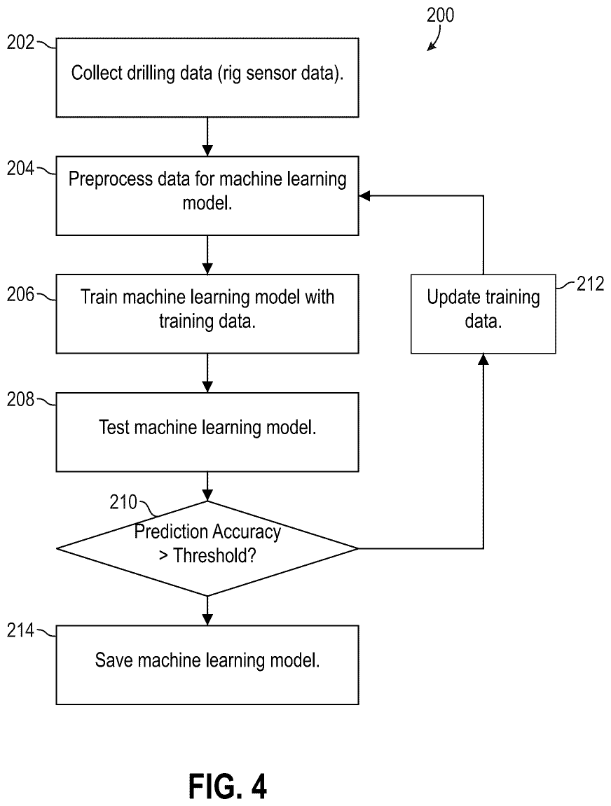

Turning now to FIG. 4, a process 200 is illustrated to develop a machine learning model of the present disclosure for used by the disclosed control apparatus (100). To train the machine learning model, a computer system (e.g., the control apparatus (100) or some other computer system) can obtain historic sensor data collected with the milling system (10) during one or more historic milling operations (Block 202). For example, the historic sensor data can be collected at least from one or more offset wells of the wellbore, although other historical sensor data and even modelled sensor data can be used. The collected sensor data is divided into input data and output (target) data. Of course, the input data includes variables or conditions used to make predictions in the model. The output (target) data includes variables that model is trying to predict.

The computer system preprocesses the historic sensor data into training data for the machine learning model (Block 204). Preprocessing puts the historical data into data structures suitable for the machine learning model. For example, preprocessing can clean the training date to account for missing values, remove outliers, and correct inconsistencies. Additionally, because the data may relate to different wells, system configurations, and the like, the training data may need to be normalized and standardized, such as by scaling the data so that the features have similar ranges or distributions. Encoding or conversion of the data into other formats may also be necessary.

The computer system trains the machine learning model with the training data (Block 206). For example, to train the machine learning model with the training data, the computer system can use a regression model. Several types of regression algorithms can be used in the model, including, for example, linear regression, polynomial regression, support vector regression (SVR), decision trees, random forests, and neural networks. The regression model is a type of machine learning model used to predict a continuous output variable based on one or more input variables.

Training can involve initialization of the model by setting initial parameters or weights for the model. The training data is divided into a training subset and a testing subset. The model uses the training data to learn the relationship between input variables and output (target) variables. This learning involves optimizing the model's parameters so a difference between predicted values and actual target values can be minimized. A loss function, such as Mean Squared Error (MSE) and Mean Absolute Error (MAE), can be used to measure the error of the model's predictions. Additionally, an optimization algorithm, such as gradient descent, can be used to minimize the loss function by iteratively adjusting the model's parameters.

The process then follows testing the machine learning model to evaluate its accuracy (Block 208). For example, the computer system can compare a prediction accuracy of the trained machine learning model relative to a threshold by testing the trained machine learning model (Decision 210). The testing subset can be used to evaluate how well the model performs on unseen data. A number of evaluation metrics can be used by the regression model and can include: R-squared (R²) measuring the proportion of variance in the target variable that can be explained by the input features; Root Mean Squared Error (RMSE) as the square root of the average squared differences between predicted and actual values; and Mean Absolute Error (MAE) as the average of the absolute differences between predicted and actual values.

Further updating may be required for the machine learning model is required if the accuracy is not technically accepted (Block 212). Otherwise, the machine learning model can be saved to be utilized in real-time deployment (Block 214). Updating can involve adjust those parameters not learned from the data but set before training (i.e., the model's hyperparameters), such as learning rate or the number of trees in a random forest, to improve performance. Also, techniques, such as k-fold cross-validation, can be used to ensure the model's performance is consistent across different subsets of the data.

Of course, in deployment, the trained model is integrated into an environment to make predictions on new data. Continuous monitoring of the model's performance can be performed by the computer system so the model is updated as needed to ensure it remains accurate over time.

FIG. 5 illustrates an example configuration 300 for a computer system to train and deploy a machine learning algorithm 320 for use in a machine learning model disclosed herein. In one arrangement, the configuration 300 can focus on a package of various machine learning algorithms so a desired machine learning algorithm 320 with the highest accuracy can be selected for use.

To start the model development, an untrained version of a machine learning algorithm 320 (i.e., an untrained machine learning algorithm 321a) is trained by a training framework 310 using a training dataset 302 to produce a trained version of the machine learning algorithm 320 (i.e., a trained machine learning algorithm 321b).

To begin the training, initial hyperparameters of the untrained machine learning algorithm 321a are configured and optimized using sensitivity analysis for the algorithm's structure. The training cycle can then be performed by the training framework 310 to produce the trained machine learning algorithm 321b.

In one arrangement of the configuration 300, the training cycle can be performed in a supervised manner. In particular, supervised learning can use the training dataset 302 to teach the machine learning algorithm 320 to yield a desired output. Accordingly, the training dataset 302 includes inputs and desired outputs, which allow the machine learning algorithm 320 to learn over time. Alternatively, when the training dataset 302 includes inputs having known outputs, the outputs of the machine learning algorithm 320 can be manually graded.

The configuration 300 processes the inputs and compares the resulting outputs against a set of expected or desired outputs. Errors are then propagated back through the training framework 310 to further train the machine learning algorithm 320. In turn, the training framework 310 can adjust to change the hyperparameters that control the untrained machine learning algorithm 321a. The training framework 310 can also provide tools to monitor how well the untrained machine learning algorithm 321a is converging towards a model suitable for generating correct answers based on known input data.

The training process repeatedly occurs as the algorithm's hyperparameters are adjusted to refine the outputs generated by the machine learning algorithm 320. The training process can continue until the trained machine learning algorithm 321b reaches a statistically desired accuracy. At this point, the trained machine learning algorithm 321b can be deployed to implement any number of machine learning operations in which the trained machine learning algorithm 321b processes a new data 322 to output model predictions and results 324.

Supervised learning is typically separated into two types of problems-classification and regression. Classification uses an algorithm to assign the training dataset 302 accurately into specific categories. Regression is used to understand the relationship between dependent and independent variables. Numerous different algorithms and computation techniques can be used in supervised machine learning, including but not limited to, a neural network, naïve bayes, linear regression, logistic regression, support vector machines (SVM), k-nearest neighbor, and random forest.

If unsupervised learning is used, the configuration 300 can use algorithms to analyze and cluster unlabeled data. These algorithms discover hidden patterns or data groupings. Therefore, the training dataset 302 can include input data without any associated output data. The untrained machine learning algorithm 321a can learn groupings within the unlabeled input and determine how individual inputs relate to the overall dataset. Unsupervised training can be used for three main tasks-clustering, association, and dimensionality. Clustering is a data mining technique that groups unlabeled data based on similarities and differences. This technique is often used to process raw, unclassified data objects into groups represented by structures or patterns in the information. Association is a rule-based method for finding relationships between variables in a given dataset. This method is often used for market basket analysis. Dimensionality reduction is used when a given dataset's number of features (dimensions) is too high. This technique is commonly used in the preprocessing of data.

Variations of supervised and unsupervised training may also be employed. Semi-supervised learning is a technique in which the training dataset 302 includes a mix of labeled and unlabeled data of the same distribution. Incremental learning is a variant of supervised learning in which input data is continuously used to train the machine learning algorithm 320 further. Incremental learning enables the trained machine learning algorithm 321b to adapt to the new data 322 without forgetting the knowledge instilled within the configuration 300 during initial training.

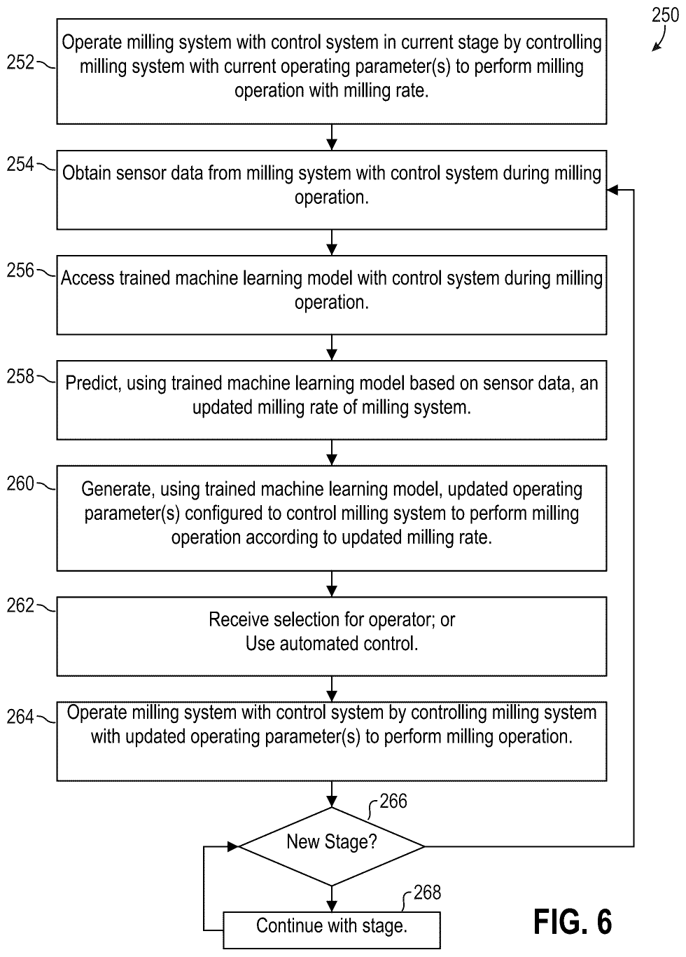

Having an understanding of how to train and deploy a machine learning model of the present disclosure, discussion now turns to details in which a machine learning model is used during a window milling operation. In particular, FIG. 6 illustrates a process 250 used to mill a window in casing of a wellbore disposed in a formation. To help with the following explanation, reference is made to the milling system (10) of FIG. 1, the control apparatus (100) of FIG. 3, and other elements depicted in the present disclosure.

In the process 250 of FIG. 6, the milling system (10) is operated using the control apparatus (100) by controlling the milling system (10) with one or more current operating parameters to perform a window milling operation with a milling rate (Block 252). As will be appreciated, technical aspects during the milling operation have to be carefully considered so an efficient job can be performed, non-productive time can be reduced, and a good window for the casing exit can be successfully produced for the next drilling phase. Such technical aspects can include optimizing weight on the mill (WOM) and the rotational speed (RPM), both of which can significantly impact the milling rate and downhole casing exit trajectory. As will be appreciated, improper control of milling parameters may produce undesired tracking of the existing well casing or may result in an early kick-off. As such, the milling operation operated under unoptimized milling parameters will take more time to accomplish the job because an unnecessary low milling rate may be used. In the end, any unsuccessful casing exit operation may require extra milling runs to be implemented to fix the situation.

Accordingly, during the milling operation, the control apparatus (100) obtains sensor data from the milling system (10) (Block 254), and the control apparatus (100) accesses a trained machine learning model (Block 256). (FIG. 7 discussed below illustrates an example of a machine learning model 350 utilized by the control apparatus (100) of the present disclosure.) Using the trained machine learning model (350), the control apparatus (100) predicts, based on the sensor data, an updated milling rate of the milling system (10) (Block 258).

With respect to the obtained sensor data, the control apparatus (100) can access real-time sensor data from the sensor array (50) of the milling system (10). As noted, the sensor data includes data from surface sensors and can at least include one or more of a weight on mill, a rotational speed, and a flow rate associated with the milling system (10). The sensor data can also include temperatures, pressures, drilling fluid characteristics, and the like. The sensor data can also include subsurface data, such as vibration, temperatures, pressures, and the like. The sensor data can include subsurface sensor data (obtained from milling equipment, logging equipment, etc.), surface sensor data (obtained from the rig, pumps, etc.), and metadata (location, mud system, milling system (10), geometry, etc.), and the like.

As can be seen, some of the sensor data is related to parameters that can be controlled by the control apparatus (100) to configure a resulting milling rate. Primarily, the controllable parameters include weigh-on-mill (WOM), rotational speed (RPM), and flow rate (Q), which can impact the milling operation and are used for optimization of the milling rate.

Other sensor data is related to uncontrollable parameters and is dependent on other factors or conditions. Yet, the sensor data related to such uncontrollable parameters can still play a role in the resulting milling rate generated by the milling system (10), and as noted herein, the sensor data related to the uncontrollable parameters can be considered in the machine learning model (350) of the present disclosure.

Continuing in the process 250 of FIG. 6, the control apparatus (100) using the trained machine learning model (350) then generates one or more updated operating parameters (Block 260). The one or more updated operating parameters are configured to control the milling system (10) to perform the milling operation according to the updated milling rate, and the milling system (10) applies an optimized combination of these parameters can improve the milling operation's performance. As noted above, the one or more updated operating parameters can include one or more of an updated weight on mill, an updated rotational speed, and an updated flow rate.

For example, a prediction module (380) of the machine learning model (350) can be run to predict a combination of the controllable milling parameters (i.e., WOM, RPM, flow rate) to achieve one or more desirable milling rates, such as a maximum milling rate, a minimum milling rate, or other optimal milling rate to achieve efficient milling. The desirable milling rate can be user-selected and configurable parameter of the control apparatus (100). Then, an optimization module (390) of the machine learning model (350) in the control apparatus (100) can be operated to generate one or more of the controllable milling parameters to achieve the updated milling rate. These controllable milling parameters tell the operator (or the control apparatus (100) in an automated configuration) what changes and adjustments to perform during the milling operation to produce the selected milling rate.

In one configuration, the control apparatus (100) can provide intelligent advisory actions for the operators to perform on the rig site in real-time based on the rig sensor data. In other configurations, the control apparatus (100) can provide automated actions to be performed on the rig site in real-time. Depending on the level of automation provided by the control apparatus (100), for example, the control apparatus (100) can generate an output of the one or more updated operating parameters to be selected by an operator of the milling system (10). For example, the disclosed control apparatus (100) can provide advisory outputs (i.e., instructions, values, recommendations, etc.) for the milling operation supervisor in real-time. These outputs can be used to generate an optimization report for running the optimum values of the surface controllable parameters (e.g., the weight on the mill (WOM), rotational speed (RPM), and the pumping or flow rate (Q)) during the entire operation.

In the process 250 of FIG. 6, the control apparatus (100) can then implement the changes to the surface controllable parameters (Block 262). Different implementation options can be used. In one configuration, the control apparatus (100) can receive a selection of the at least one of the one or more updated operating parameters in the generated output. The operator can select any one or more of these controllable milling parameters based on the operator's experience and the current conditions.

Additionally, as noted, the control apparatus (100) can implement one or more of these controllable milling parameters automatically depending on the configuration of the control apparatus (100). For the automated configuration, the control apparatus (100) can automatically control the milling system (10) according to an automated control of the control apparatus (100). The automated control can adjust the milling system (10) with the at least one of the one or more updated operating parameters. For example, the disclosed system can provide automated outputs (i.e., commands, actions, controls, etc.) to be performed by components of the rig system in real-time during the milling operation. These automated outputs can adjust surface controllable parameters (e.g., the weight on the mill, rotational speed, and the pumping rate) during the entire operation.

Either way, the control apparatus (100) in the process 250 now operates the milling system (10) by controlling the milling system (10) with at least one of the one or more updated operating parameters to perform the milling operation (Block 264). In this way, the machine learning model (350) generates optimum milling parameters for a technical crew to achieve an increased, technically safe penetration rate while milling a casing milling window and drilling a rathole.

The controllable milling parameters during the operation include the weight on the mill, which is the downhole force exerted on the mill by the bottom hole milling assembly (30). The BHA of the milling assembly (30) typically uses heavy-weight drill pipe and drill collars (38) to provide the weight on the mill(s). Increasing the weight on the mill(s) can help to push the assembly and improve the milling rate. However, this action needs to be controlled carefully because there is a boundary limit (founder point) in the directly proportional relationship between the weight on the mill and the milling rate. Increasing the weight-on-mill beyond this boundary limit can lead to an inefficient milling operation and energy loss. The technical operation limit for this relationship is also a function of the rotational speed of the milling system (10) so a complex interrelationship needs to be addressed. Common practice relies on the technical experience of the crew team in milling historical offset wells to handle the interrelationship. The advisory control apparatus (100) of the present disclosure can enhance and augment the technical experience and may automate operations at least to some extent.

Milling performance can be impacted by additional parameters, which may be more indirect in nature but can be controlled to improve the performance. For example, the mud pumping rate during the milling operation can provide good hole cleaning that can enhance the milling performance. Moreover, additional uncontrollable parameters can significantly impact the milling operation performance. For example, the casing integrity at the exit point, the cement quality behind the casing (CS), and the penetrated drilled formation (F) are examples of such parameters, which cannot be controlled during the milling operation but can impact performance. Therefore, considering all of these technical aspects is not an easy task to address in a real-time milling operation.

As the one or more of the controllable milling parameters are implemented and the milling system (10) performs the milling operation, software of the control apparatus (100) determines if the milling rate is within an optimum level and logs information (generates optimization reports). The process 250 of FIG. 6 can be repeated any number of times during any suitable time interval during the milling operation.

In particular, the process 250 as disclosed herein can operate in stages of the window milling operation to produce a casing exit. As the current stage is milled, the process 250 can repeat for any additional stages to be milled in the milling operation (Decision 266, Block 268). Thus, the updated milling rate may be predicted for a current stage of a plurality of the discrete stages for the milling operation, and the one or more updated operating parameters generated and adjusted by the control apparatus (100) can be suited to the current stage of the milling operation. A determination can be made whether a new stage has been reached in the milling operation so the process can be repeated to optimize the milling operation in this new stage (Decision 266).

As disclosed herein, each of the discrete stages can be defined by a change in physics of the milling system (10) during the milling operation. For example, the discrete stages can include a cutout stage, a maximum deflection stage, a core point stage, a kickoff stage, and the like. In general, each of the discrete stages can be defined by one or more of: location information for known or expected events during a window milling operation; geometric distances from a known reference point; types, sizes, and arrangements of milling assembly (30) and whipstock (40); a configuration of the milling system (10), a dimension (e.g., size or weight) of the casing, a characteristic of the formation, an angle of attack, and the like.

Briefly, FIG. 7 illustrates an example of a machine learning model 350 utilized by a control apparatus (100) of the present disclosure. The model 350 received inputs 352, which include controllable parameters and raw real-time data. The controllable parameter can currently be fixed and free-floating in the operation, and the raw real-time date can be for a predetermined period. A preprocessing module 360 preprocess the inputs to generate derived features. As already noted, the preprocessing can prepare the inputs for handling by the model 350 and can involve categorizing the inputs, inserting missing data, etc.

A payload builder module 370 builds payloads of the derived features in batch jobs to facilitate processing. A prediction module 380 uses a regression algorithm 382 to make predictions, which can be arranged in batch jobs. Finally, an optimizer module 390 takes the predictions from the regression algorithm 382 and provides outputs 354 for the control of the milling operation. The outputs 354 include optimum controllable parameters (e.g., WOM, RPM, Q) for the milling operation that have been predicted by the model 350. Additionally, the outputs 354 include an optimum milling rate associated with the controllable parameters predicted by the model 350.

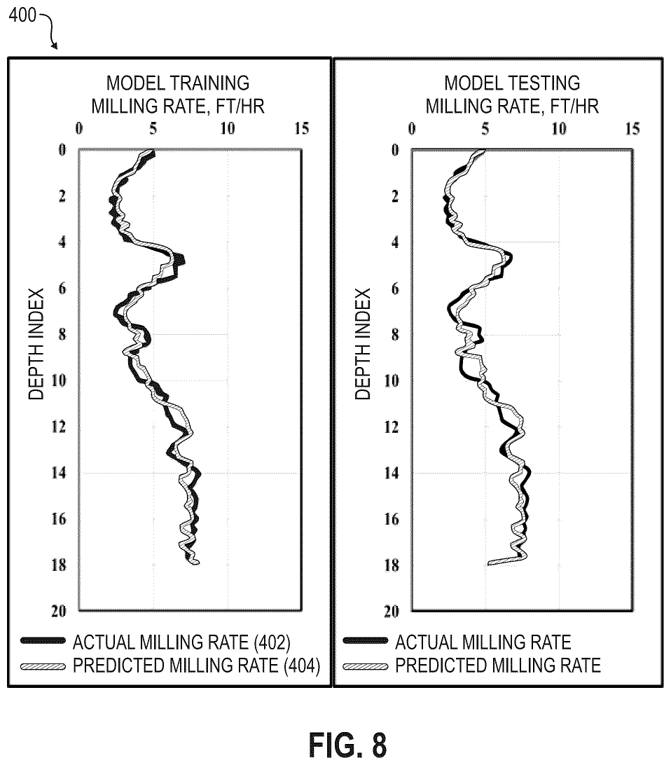

FIG. 8 illustrates an example graph 400 comparing a predictive accuracy of the disclosed machine learning model for predicting a milling rate. As noted, the machine learning model disclosed herein is trained using training data and is then tested with test data. In the graphs 400, an actual recorded milling rate 402 from test data is depicted relative to a depth index from a historic offset well. The trained model of the present disclosure is then provided historic parameters from the milling operations to predict a predicted milling rate 404, which is depicted on the graph 400 for comparison. Correlation between the actual and predicted milling rates 402, 404 can be determined so a value for the accuracy of the disclosed machine learning model can be defined. When the accuracy has an acceptable value, the trained model can be used in a live milling operation.

The graph 400 represents in a graphic form for current understanding how the disclosed machine learning model can be trained and tested to determine how well the trained model can predict milling rates based on training data (i.e., historical sensor data related to controllable and uncontrollable parameters of previous real-world milling operations or simulated data). The predicted milling rate 404 produced by the model can then be compared to the actual milling rate 402 so the accuracy and the validity of the model can be assessed.

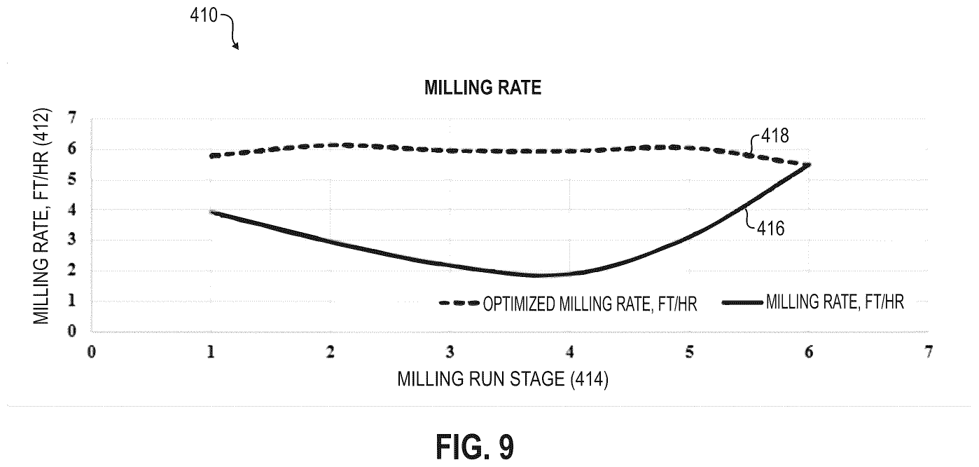

FIG. 9 illustrates an example graph 410 showing the improvements in milling rate produced by the disclosed machine learning model during a milling operation in real-time. The graph 410 shows an actual conventional milling rate 416 (achieved without the disclosed model) versus an optimized milling rate 418 (achieved with the disclosed model). The comparison shows how the optimization provided by the disclosed machine learning model achieves an increase in the milling rate, which is more efficient and beneficial.

Values 412 of the milling rates 416, 418 are graphed for milling run stages (e.g., cutout, deflection, core point, kickoff point) of the milling operation. Again, the particular stages 414 involved depend on the specifics of the milling system (10) (e.g., its geometry, mills, type of milling blades, etc.) and depend on the specifics of the milling environment (e.g., casing wall thickness, cement thickness, formation characteristics, angle of attack, etc.). In general, these stages 414 indicate points, intervals, transitions, etc. in the milling operation in which the physics of the milling operation change or transition. For instance, one stage 414 would correspond to initial milling of casing by the milling system (10), which would involve particular physics related to the mill being used, the mill's blades, casing material, wall thickness, angle of attack, etc. Another stage 414 would correspond to subsequent milling of the cement by the milling system (10), which would involve different physics related to the mill being used, the mill's blades, cement material, cement thickness, etc.

As shown in FIG. 9, the conventional milling rate would typically dip a significant amount during particular milling stages 414, such as when particular elements of the milling system (10) encounter unique features downhole during the milling operation. The disclosed machine learning model, however, can produce an optimal milling rate 418 that is consistent over the various stages 414 of the milling operation.

Achieving the optimal milling rate in FIG. 9 over the stages 414 involves changing the controllable parameters of weight-on-mill (WOM), rotational speed (RPM), and flow rate (Q) of the milling rate as the milling system (10) progresses through the stages 414.

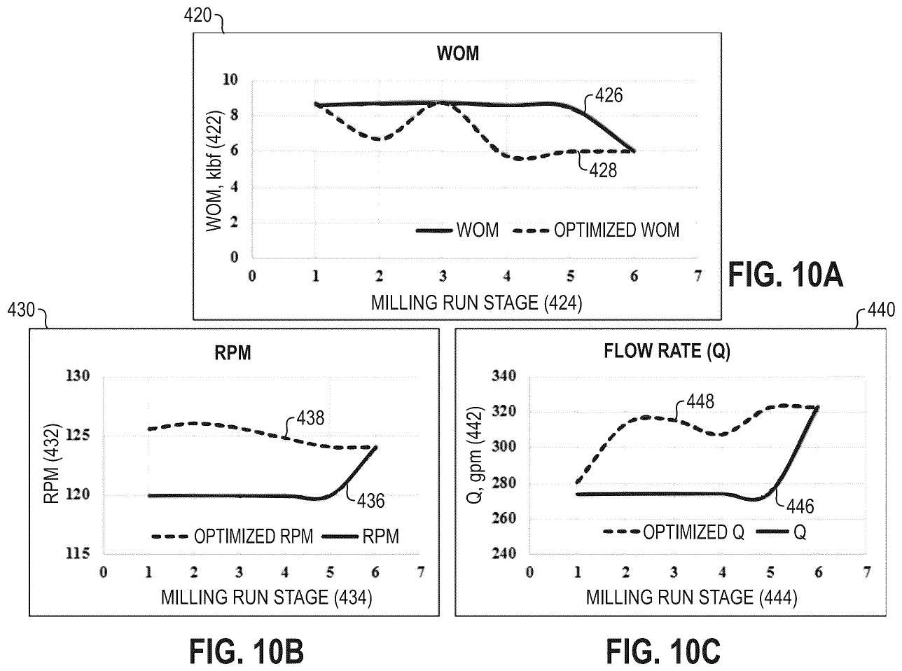

For example, FIGS. 10A, 10B, and 10C show example graphs 420, 430, 440 of changes to the controllable parameters to achieve the optimal milling rate noted above. The graphs 420, 430, 440 show outputs of the optimized milling parameters achieved using the machine learning model versus the conventional values implemented without the model in an example milling operation. The graphs 420, 430, 440 present parameter values 422, 432, 442 for an optimized weight-on-mill (WOM) parameter 428, an optimized rotation (RPM) parameter 438, and an optimized pumping or flow rate (Q) parameter 448 with respect to conventional parameters 426, 436, 446. Again, the parameter values 422, 432, 442 are plotted relative to milling run stages 424, 434, 444. Combined, these outputs for these optimization parameters 428, 438, 448 produce an optimized milling rate as noted in FIG. 9.

In one aspect, the disclosed control apparatus (100) can provide visualization dashboards for operators to see and control the milling operation in real-time. To aid in decision-making, the visualization dashboards can provide real-time sensor data, such as hole depth, bit depth, milling rate, weight on the mill, hook load, string rotational speed, drilling torque, mud pumping flow rate, and pumping pressure. Additionally, the visualization dashboards can provide real time progress of the window milling operation as the casing exit and rathole are drilled.

In another aspect, the disclosed control apparatus (100) can provide various levels of reporting to operators during the milling operation. Operational reporting can be directed to quick decision actions to be implemented during each stage of the milling operation. The operational reporting can allow operators to select optimized parameters (if current milling parameters are not in the optimum level) or to take no action (if current milling parameters are in the optimum level). The operational reporting can show optimized values for the three parameters (weight on mill, rotational speed, and pumping rate) and can alert the operator to either increase or decrease for the current values for these controllable milling parameters.

Advanced analytics reporting can provide more technical details and analytics for each stage of the milling operation. The analytics reporting can use real-time sensor data, optimized values for controllable milling parameters, actual versus optimized milling rate, and operation improvements in ratios. The analytics reporting can provide cost savings based on the reduction in time because the disclosed machine learning model is used in milling the casing exit. The outputs for the analytics reporting can provide key performance indicators (KPI) so the performance and efficiency of the milling operation can be tracked and used for further improvements.

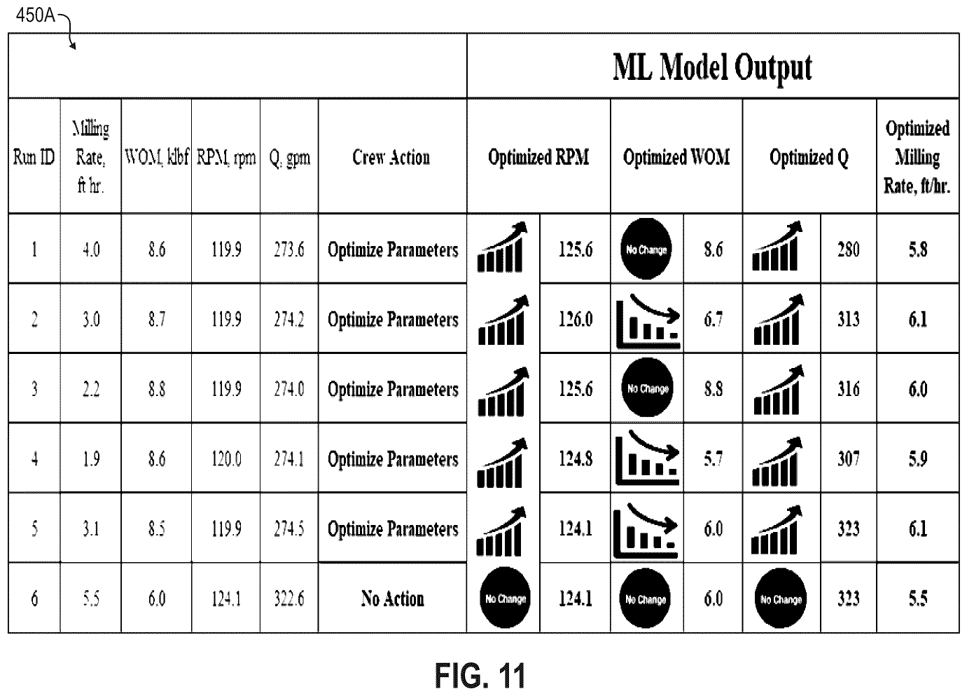

Consistent with the above visualization and reporting aspects noted above, FIG. 11 illustrates an example representation 450A for the operational controls produced by the disclosed machine learning model. For the milling stages (run ID), the operational outputs show current values for a current milling rate produced by current controllable parameters of the weight-on-mill (WOM) parameter, the rotation (RPM) parameter, and the flow rate (Q) parameter. The machine learning model generates optimized outputs for an updated weight-on-mill (WOM) parameter, an updated rotation (RPM) parameter, and an updated flow rate (Q) parameter, which produces an updated (predicted) milling rate.

The operational outputs can be provided in a visual display of the control apparatus (100) for a job supervisor to manually review and select changes for implementation on the rig. For example, the operational outputs can include instructions for the crew to either increase, decrease, or maintain (make no change to) the operational parameters that control the milling system (10) so the optimized milling rate can be achieved.

Likewise, the operational outputs can be provided in a visual display of the control apparatus (100) and may be automatically implemented. For example, automated outputs can be generated by the machine learning model for the milling system (10) to automatically implement on the rig (15). These automated outputs can be performed as automated controls to the milling system (10). As is customary, these automated controls can be implemented under the supervision and acceptance of the operators.

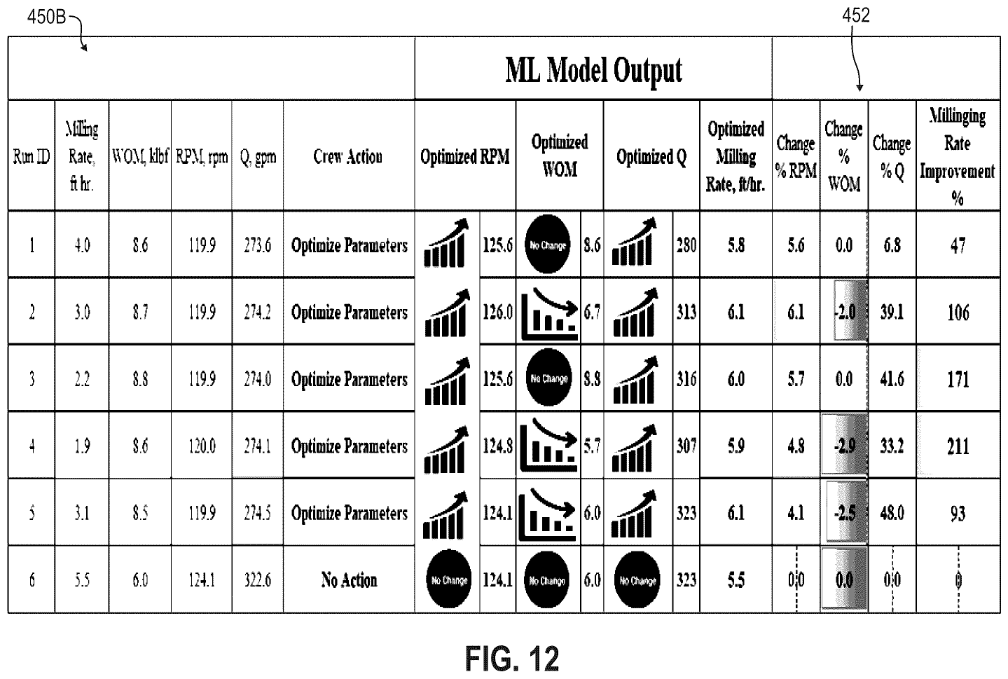

FIG. 12 illustrates another example representation 450B having some advanced engineering analytics 452 for optimization runs generated by the machine learning model. The advanced engineering analytics 452 can be implemented for further understanding improvements in the milling rate and changing the milling parameters within acceptable ranges. The analytics 452 shown here include percentage of change in the operational parameters and the percentage of improvement in the milling rate. The provided analytics 452 can show operators if the optimized changes represent a large or small increase/decrease in the controllable parameters. The operators can use these analytics 452 in deciding which one or more of the controllable parameters to change at a current time and stage depending on experience and current conditions. Additionally, the control apparatus (100) can use the analytics 452 to cap changes to the controllable parameters to only a predefined percent change so smaller, less drastic changes may only be offered to the controllable parameters.

In summary, the machine learning model (350) of the milling system (10) optimizes a milling operation. To do this, the control apparatus (100) applies advanced data analytics and machine learning to real-time sensor data to fully model the milling operation. The machine learning model (350) is trained based on historical data from wells and is tested on live jobs to fully capture an interrelationship pattern between the drilling data and the milling rate. Then, an optimization technique is implemented to generate an optimized combination of controllable drilling parameters for the crew on a rig site so the control apparatus (100) can help maximize the objective milling rate. Consequently, the technology-based tools disclosed herein can help maximize the value of the recorded rig sensor data during the casing exit operation and can provide data-driven decision-making to guide the job supervisor optimized values of the surface controllable parameters recommended by the disclosed control apparatus (100). The disclosed control apparatus (100) provides an integrated machine learning technical solution that integrates advanced data analytics and the technical knowledge within an optimized machine learning model (350) for maximizing the milling rate by generating optimized milling parameters (e.g., weight on mill, rotational speed, pumping rate, etc.). The developed machine learning model (350) is trained using satisfactory historical data within the field of interest for successful cases for running the casing exit for a specific casing size. The trained model (350) captures a comprehensive relationship between the milling rate and the surface drilling parameters (e.g., weight on mill, hook load, pumping rate, standpipe pressure, rotational speed, and surface drilling torque). Consequently, the developed model (350) with an optimizer module (390) can be run for real-time jobs to generate optimized milling parameters to produce a maximized milling rate applicable to the implementation at hand.

In another aspect, the integrated control apparatus (100) can be used at the rig site or via a real-time operations center (RTOC) for efficient remote collaboration that significantly impacts the job performance toward safe efficient operation with cost saving by reducing the operation running time as reported for many application around the globe. Many important information and documents during the job planning are very critical and require to be revisited during the operation in some situations. This kind of data includes information about window milling, rathole, casing data, whipstock type, milling assembly (30), and others. The disclosed control apparatus (100) linked with the real-time data from the rig (15) through a data transmission protocol aggregating all the data sources even within the job planning phase in one place for close monitoring and efficient execution of the milling operation.

Aspects of the present disclosure can be characterized by the following clauses:
Clause 1. A method used to mill a window in casing (12) of a wellbore disposed in a formation, the method comprising:
operating a milling system (10) with a control apparatus (100) by controlling the milling system (10) with one or more current operating parameters to perform a milling operation with a milling rate;
obtaining sensor data from the milling system (10) with the control apparatus (100) during the milling operation;
accessing a trained machine learning model (350) with the control apparatus (100) during the milling operation;
generating, with the control apparatus (100) using the trained machine learning model (350) and the sensor data, an updated milling rate of the milling system (10);
generating, with the control apparatus (100) using the trained machine learning model (350), one or more updated operating parameters, the one or more updated operating parameters being configured to control the milling system (10) to perform the milling operation according to the updated milling rate; and
operating the milling system (10) with the control apparatus (100) by controlling the milling system (10) with at least one of the one or more updated operating parameters to perform the milling operation.
Clause 2. The method of Clause 1, wherein the sensor data includes one or more of: a weight on mill, a rotational speed, and a flow rate associated with the milling system (10); and wherein the one or more updated operating parameters include one or more of: an updated weight on mill, an updated rotational speed, and an updated flow rate.
Clause 3. The method of Clause 1 or 2, comprising initially training an untrained machine learning model (312) with the control apparatus (100) by: obtaining historic sensor data collected during one or more historic milling operations;
preprocessing the historic sensor data into training data for the untrained machine learning model (318);
training the untrained machine learning model (318) with the training data to generate the trained machine learning model (350);
comparing a prediction accuracy of the trained machine learning model (350) relative to a threshold by testing the trained machine learning model (350); and saving the trained machine learning model (350) or repeating the training based the comparison.
Clause 4. The method of Clause 3, wherein obtaining the historic sensor data collected during the one or more historic milling operations comprises obtaining the historic sensor data collected at least from one or more offset wells of the wellbore.
Clause 5. The method of Clause 3 or 4, wherein training the machine learning model with the training data comprises using an artificial intelligence regression model.
Clause 6. The method of any one of Clauses 1 to 5, wherein operating the milling system (10) with the control apparatus (100) comprises:
generating an output of the one or more updated operating parameters to be selected by an operator of the milling system (10);
receiving a selection of the at least one of the one or more updated operating parameters in the generated output; and
using the selection when operating the milling system (10) with the control apparatus (100).
Clause 7. The method of any one of Clauses 1 to 6, wherein operating the milling system (10) with the control apparatus (100) comprises automatically controlling the milling system (10) according to an automated control of the control apparatus (100), the automated control adjusting the milling system (10) with the at least one of the one or more updated operating parameters.
Clause 8. The method of any one of Clauses 1 to 7, wherein generating the updated milling rate comprises generating a plurality of the updated milling rate, each of the plurality being associated with one of a plurality of discrete stages of the milling operation.
Clause 9. The method of Clause 8, wherein:
generating the one or more updated operating parameters comprises generating a plurality of the one or more updated operating parameters, each of the plurality being associated with one of the discrete stages; and
controlling the milling system (10) with the at least one of the one or more updated operating parameters to perform the milling operation comprises adjusting the milling system (10) with the at least one of the one or more updated operating parameters in at least one of the discrete stages.
Clause 10. The method of Clause 8 or 9, wherein each of the discrete stages is defined by a change in physics of the milling system (10) during the milling operation.
Clause 11. The method of Clause 8, 9 or 10, wherein each of the discrete stages is defined by one or more of: a location for an event during the milling operation, a geometric distance from a known reference point, a configuration of the milling system (10), a configuration for a milling assembly (30) of the milling system (10), a dimension of the casing (12), a characteristic of the formation, an angle of attack, a point at which cutting for a given mill begins, a point at which cutout for a given mill begin, an amount of deflection, a cutout point, a core point, and a kickoff point in the milling operation.
Clause 12. A non-transitory program storage device having program instructions stored thereon for causing one or more processors to perform a method of Clause 1 to 11 to mill a window in casing (12) of a wellbore disposed in a formation.
Clause 13. A system used in casing (12) of a wellbore disposed in a formation, the system comprising:
a milling assembly (30) being configured to mill a window in the casing (12) during a milling operation;
a plurality of sensors configured to obtain sensor data at least associated with the milling assembly (30);
a control apparatus (100) in operable communication with the milling assembly (30) and the sensors, the control apparatus (100) being configured to perform a milling operation according to any one of Clauses 1 to 11 to mill a window in casing (12) of a wellbore disposed in a formation.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A method used to mill a window in casing of a wellbore disposed in a formation, the method comprising:
operating a milling system with a control apparatus by controlling the milling system with one or more current operating parameters to perform a milling operation with a milling rate;
obtaining sensor data from the milling system with the control apparatus during the milling operation;
accessing a trained machine learning model with the control apparatus during the milling operation;
generating, with the control apparatus using the trained machine learning model and the sensor data, an updated milling rate of the milling system;
generating, with the control apparatus using the trained machine learning model, one or more updated operating parameters, the one or more updated operating parameters being configured to control the milling system to perform the milling operation according to the updated milling rate; and
operating the milling system with the control apparatus by controlling the milling system with at least one of the one or more updated operating parameters to perform the milling operation.

2. The method of claim 1, wherein the sensor data includes one or more of: a weight on mill, a rotational speed, and a flow rate associated with the milling system; and wherein the one or more updated operating parameters include one or more of: an updated weight on mill, an updated rotational speed, and an updated flow rate.

3. The method of claim 1, comprising initially training an untrained machine learning model with the control apparatus by:
obtaining historic sensor data collected during one or more historic milling operations;
preprocessing the historic sensor data into training data for the untrained machine learning model;
training the untrained machine learning model with the training data to generate the trained machine learning model;
comparing a prediction accuracy of the trained machine learning model relative to a threshold by testing the trained machine learning model; and
saving the trained machine learning model or repeating the training based the comparison.

4. The method of claim 3, wherein obtaining the historic sensor data collected during the one or more historic milling operations comprises obtaining the historic sensor data collected at least from one or more offset wells of the wellbore.

5. The method of claim 3, wherein training the machine learning model with the training data comprises using an artificial intelligence regression model.

6. The method of claim 1, wherein operating the milling system with the control apparatus comprises:
generating an output of the one or more updated operating parameters to be selected by an operator of the milling system;
receiving a selection of the at least one of the one or more updated operating parameters in the generated output; and
using the selection when operating the milling system with the control apparatus.

7. The method of claim 1, wherein operating the milling system with the control apparatus comprises automatically controlling the milling system according to an automated control of the control apparatus, the automated control adjusting the milling system with the at least one of the one or more updated operating parameters.

8. The method of claim 1, wherein generating the updated milling rate comprises generating a plurality of the updated milling rate, each of the plurality being associated with one of a plurality of discrete stages of the milling operation.

9. The method of claim 8, wherein:
generating the one or more updated operating parameters comprises generating a plurality of the one or more updated operating parameters, each of the plurality being associated with one of the discrete stages; and
controlling the milling system with the at least one of the one or more updated operating parameters to perform the milling operation comprises adjusting the milling system with the at least one of the one or more updated operating parameters in at least one of the discrete stages.

10. The method of claim 8, wherein each of the discrete stages is defined by a change in physics of the milling system during the milling operation.

11. The method of claim 8, wherein each of the discrete stages is defined by one or more of: a location for an event during the milling operation, a geometric distance from a known reference point, a configuration of the milling system, a configuration for a milling assembly of the milling system, a dimension of the casing, a characteristic of the formation, an angle of attack, a point at which cutting for a given mill begins, a point at which cutout for a given mill begin, an amount of deflection, a cutout point, a core point, and a kickoff point in the milling operation.

12. A non-transitory program storage device having program instructions stored thereon for causing one or more processors to perform a method of claim 1 to mill a window in casing of a wellbore disposed in a formation.

13. A system used in casing of a wellbore disposed in a formation, the system comprising:
a milling assembly being configured to mill a window in the casing during a milling operation;
a plurality of sensors configured to obtain sensor data at least associated with the milling assembly;
a control apparatus in operable communication with the milling assembly and the sensors, the control apparatus being configured during the milling operation to:
obtain the sensor data from the sensors;
access a trained machine learning model;
generate, using the trained machine learning model and the sensor data, an updated milling rate of the milling assembly;
generate, using the trained machine learning model, one or more updated operating parameters, the one or more updated operating parameters being configured to control the milling assembly to perform the milling operation according to the updated milling rate; and
control the milling assembly with at least one of the one or more updated operating parameters to operate the milling assembly.

14. The system of claim 13, wherein the sensor data includes one or more of a weight on mill, a rotational speed, and a flow rate associated with the system; and
wherein the one or more updated operating parameters include one or more of an updated weight on mill, an updated rotational speed, and an updated flow rate.

15. The system of claim 13, wherein to operate the milling assembly, the control apparatus is configured to:
generate an output of the one or more updated operating parameters to be selected by an operator of the milling assembly;
receive a selection of the at least one of the one or more updated operating parameters in the generated output; and
use the selection in the operation of the milling assembly.

16. The system of claim 13, wherein to operate the milling assembly, the control apparatus is configured to automatically control the milling assembly according to an automated control of the control apparatus, the automated control being configured to adjust the milling assembly with the at least one of the one or more updated operating parameters.

17. The system of claim 13, wherein to generate the updated milling rate, the control apparatus is configured to generate a plurality of the updated milling rate, each of the plurality being associated with one of a plurality of discrete stages of the milling operation.

18. The system of claim 17, wherein the control apparatus is configured to:
generate a plurality of the one or more updated operating parameters, each of the plurality being associated with one of the discrete stages; and
adjust the milling assembly with the at least one of the one or more updated operating parameters in at least one of the discrete stages to control the milling assembly with the at least one of the one or more updated operating parameters to perform the milling operation.

19. The system of claim 17, wherein each of the discrete stages is defined by a change in physics of the milling assembly during the milling operation.

20. The system of claim 17, wherein each of the discrete stages is defined by one or more of: a location for an event during the milling operation, a geometric distance from a known reference point, a configuration of the milling assembly, a configuration for a milling assembly of the milling assembly, a dimension of the casing, a characteristic of the formation, an angle of attack, a point at which cutting for a given mill begins, a point at which cutout for a given mill begin, an amount of deflection, a cutout point, a core point, and a kickoff point in the milling operation.
